(19) United States
(12) Patent Application Publication
(10) Pub. No.: US 2012/0284445 A1
(43) Pub. Date: Nov. 8, 2012

(54) Redundant Electrical Network Between Remote Electrical Systems and a Method of Operating Same

(76) Inventor: Geddielee Milton Parry, Clintonville, WI (US)

(21) Appl. No.: 13/464,865

(22) Filed: May 4, 2012

Related U.S. Application Data
(60) Provisional application No. 61/482,490, filed on May 4, 2011.
(60) Provisional application No. 61/641,360, filed on May 2, 2012.

(51) Int. Cl. G06F 13/14

(52) U.S. Cl. 710/305

(57) ABSTRACT

A redundant electrical connection network may include a first electronic system having a first processor, a second, remote electric system having a second processor, a first communication link coupled between the first and second processors, and a second communication link coupled between the first and second processors. The second communication link may be separate and isolated from the first communication link, and the first and second processors may be configured to normally conduct data communications solely via one of the first and second communication links, and at least one of the first and second processors may be configured to monitor the one of the first and second communication links and re-route the data communications solely to the other of the first and second communication links upon detection of loss of the one of the first and second communication links.

### CROSS-REFERENCE TO RELATED U.S. PATENT APPLICATIONS

This patent application claims the benefit of, and priority to, U.S. provisional patent application Ser. No. 61/482,490, filed May 4, 2011, and to U.S. provisional patent application Ser. No. 61/641,360, filed May 2, 2012, the disclosures of which are each incorporated herein by reference.

### FIELD OF THE INVENTION

The present invention relates generally to apparatuses and methods for electrically connecting two remote electrical or electronic systems, and more specifically to such apparatuses and methods that include redundant connections in and between such systems to provide for continued electrical connection and communication in and between the systems in the event of connection failure.

### BACKGROUND

Electrical systems remote from each other may typically include an electrical connection system having a plurality of wires electrically connected in and between the two systems. It is desirable to provide some amount of redundancy in such an electrical connection system so that the electrical systems remain electrically connected in the event of failure of one or more or more electrical connection wires, cables, components or the like.

### BRIEF DESCRIPTION OF THE DRAWINGS

FIG. 1 is a block diagram of one illustrative embodiment of two remote electrical systems including a redundant electrical network connected thereto.

FIG. 2 is a block diagram of one illustrative embodiment of a redundant electrical network established between the two remote electrical systems illustrated in FIG. 1.

FIG. 3 is a block diagram of an alternate embodiment of a redundant electrical network established between the two remote electrical systems illustrated in FIG. 1.

FIG. 4 is a block diagram of one illustrative embodiment of a system which includes three interconnected pairs of remotely connected electrical systems with each pair including redundant electrical networks therebetween, along with a monitoring and diagnostic system coupled to at least one of the interconnected pairs.

FIGS. 5 and 6 depict a flowchart of one illustrative process for detecting loss of connection of one electrical network and rerouting the connection via the other network in either of the embodiments illustrated in FIGS. 2 and 3.

FIG. 7 is a flowchart of one illustrative process for monitoring and diagnosing error and failure conditions in the system illustrated in FIG. 4.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

In the illustrated embodiments, a redundant electrical system includes dual and redundant electrical networks between two remote electrical systems. In the event that one or more electrical connections in one of the network paths is lost due to damage, disconnect or other event or condition, one or more electrical connections in the other network path is/are used to restore and maintain electrical connection between the two systems. The disclosed system further includes monitoring logic for monitoring and alerting error and fault conditions associated with the network, and may further include diagnostic logic for diagnosing such error and/or failure conditions associated with the network. It will be understood that while the redundant electrical system is disclosed in the context of two remote electrical systems, the concepts described herein are directly applicable to systems containing a series or parallel connection of any number of pairs of remote electrical systems.

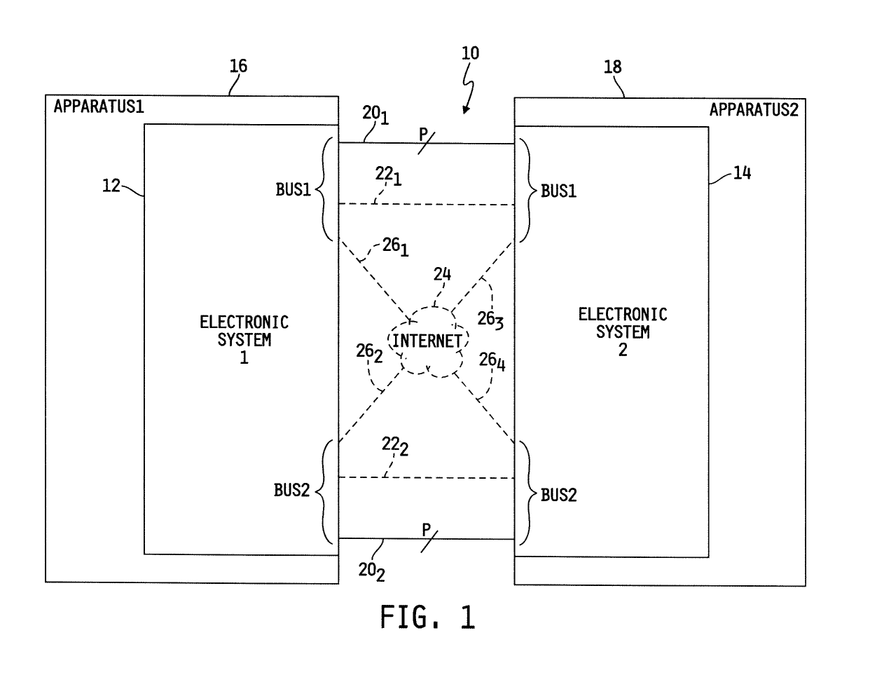

Referring now to FIG. 1, an embodiment is shown of a system 10 of dual and redundant networks electrically connected to and between two remote electrical systems 12 and 14. In the illustrated embodiment, the electronic system 12 is part or mounted to one apparatus 16 and the electronic system 14 is part of or mounted to another apparatus 18 that is separate and remote from the apparatus 16. Alternatively, the apparatus 16 may be part of or integral with the apparatus 18, and is such embodiments the electronic system 12 is remote from the electronic system 14.

In the illustrated embodiment, the dual and redundant networks include a pair of data communication link or buses, BUS1 and BUS2, each connected at opposite ends to separate communication ports of the electronic system 12 and 14. The buses, BUS1 and BUS2, are illustratively serial data communication structures, and the electronic systems 12 and 14 and buses, BUS1 and BUS2, are all configured to for communication according to a conventional serial data communications protocol. In one specific embodiment, for example, the buses, BUS1 and BUS2, are configured as a conventional control area network (CAN), and the electronic systems 12 and 14 are accordingly configured for communication via the buses, BUS1 and BUS2, according to the conventional CAN communication protocol. It will be understood, however, that the buses, BUS1 and BUS2, and the electronic systems 12 and 14 may alternatively be configured for communications according to one or more other conventional serial communication protocol. In still other embodiments, the buses, BUS1 and BUS2, may be parallel data communication structures, and in such embodiments the buses, BUS1 and BUS2, and the electronic systems 12 and 14 may all be configured for communications according to one or more conventional parallel data communication protocols.

Each of the buses, BUS1 and BUS2, may illustratively be provided in the form of a separate, conventional hardwire bus 20₁ and 20₂ respectively, each having P physical wires, where P may be any positive integer. Alternatively or additionally, either or both of the buses, BUS1 and BUS2, may be provided in the form of one or more conventional wireless buses. In one embodiment, for example, the electronic systems 12 and 14 may be configured to communicate with each other via radio frequency (RF) or other electromagnetic signals, and in such embodiments the wireless BUS1 is represented in FIG. 1 as a wireless communication path or channel 22₁ and the wireless bus BUS2 is represented as a separate wireless communication path or channel 22₂. In another embodiment, the electronic systems 12 and 14 may be configured to communicate with each other via the internet 24 or other wireless network, and in such embodiments the wireless BUS1 is represented in FIG. 1 as an internet communication path or channel 26₁, 26₃ and the wireless bus BUS2 is represented as a separate internet communication path or channel 26₂, 26₄.

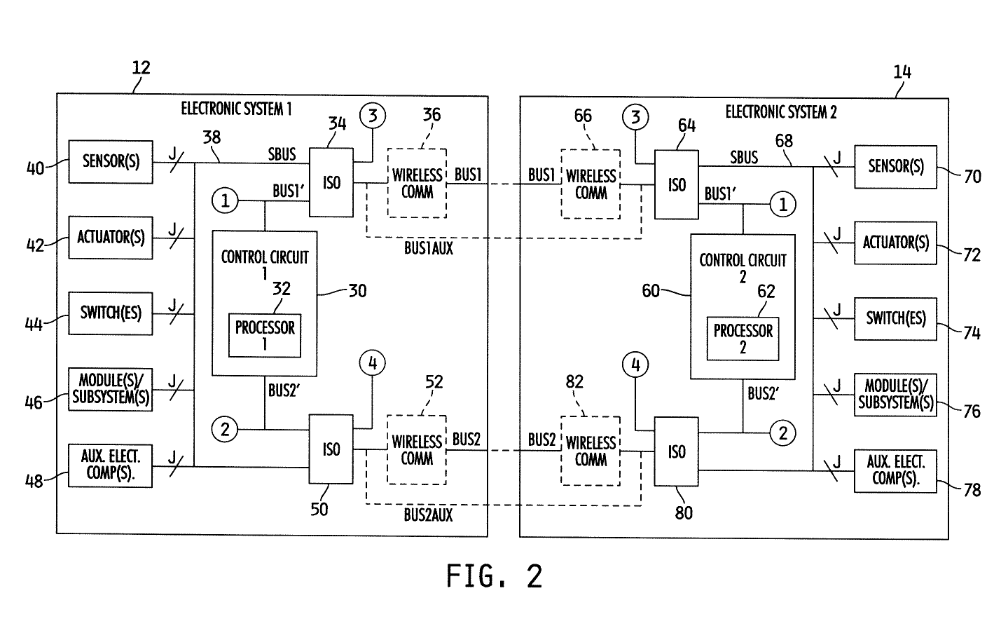

Referring now to FIG. 2, a block diagram is shown of one illustrative embodiment of a redundant electrical network established within and between the two remote electrical systems illustrated in FIG. 1. In the illustrated embodiment, the electronic systems 12 and 14 each include a control circuit 30 and 60 respectively, with each control circuit 30 and 60 including at least one conventional processor 32 and 62 respectively. In the electronic system 12, one end of a signal bus, BUS1′, is electrically connected to a communication port of the control circuit 30 and the opposite end is electrically connected to a conventional signal isolation circuit 34, e.g., a conventional opto-isolator circuit or a conventional repeater circuit. The bus BUS1 is also electrically connected to the isolation circuit 34, as is a shared bus, SBUS, 38 and a signal path labeled 3. The isolation circuit 34 is conventional in that it operates to provide data or signal coupling with electrical isolation between signal lines connected thereto. Thus, with respect to the isolator circuit 34, the shared bus, SBUS, is coupled to, yet electrically isolated from BUS1′ and BUS1. Likewise, the buses BUS2, BUST and SBUS 68 in the electronic system 14 are coupled yet electrically isolated from each other via an isolation circuit 64 which may be identical to the isolation circuit 34.

In embodiments in which BUS1 is a wireless bus, the electronic system 12 includes a wireless communication circuit 36 electrically connected via BUS1 to the isolation circuit 34 and also to the BUS1 communication port of the electronic system 12. The electronic system 14 likewise includes a wireless communication circuit 66 electrically connected via BUS2 to the isolation circuit 64 and also to the BUS2 communication port of the electronic system 14. The BUS1 interface between the two electronic systems 12 and 14, illustrated in FIG. 1 as the dashed line between the two BUS1 ports of the electronic systems 12 and 14, is thus, in this embodiment, a wireless link or channel. In embodiments in which BUS1 is a radio frequency (RF) link, the wireless communication circuits 36 and 66 may be provided in the form of conventional radio transceivers. In embodiments in which BUS1 is an internet link, the wireless communication circuits 36 and 66 may be conventional circuits configured for internet access, e.g., mobile internet access, and for communication with each other via the internet. In some embodiments in which BUS1 is a wireless bus, an auxiliary hardwire bus, BUS1AUX, may be interconnected between the isolation circuits 34 and 64 to provide for further redundancy in the BUS1 connection.

In other embodiments, BUS1 is a hardwire interface connected between the BUS1 communication ports of the two electronic circuits 12 and 14. In some such embodiments, the wireless communication circuits 36 and 66 are illustratively omitted such that the BUS1 ports of the electronic systems 12 and 14 connect directly to the isolation circuits 36 and 66. In other embodiments, the electronic circuits 12 and 14 may additionally include the wireless communication circuits 36 and 66 to provide for further redundancy, i.e., in the form of a wireless link, in the BUS1 connection. Any such redundant connection of BUS1 may include any pair or other combination of a hardwire interface, an RF or other electromagnetic interface and an internet link.

In each of the electronic systems 12 and 14, one end of another signal bus, BUS2′, is electrically connected to a communication port of the control circuits 30 and 60 respectively, and the opposite end is electrically connected to a conventional signal isolation circuit 50 and 80 respectively. The isolation circuits 50 and 80 may be identical to the isolation circuits 36 and 66 described hereinabove. Signal path connection points 1, 2 and 4 are provided in each of the systems 12 and 14 at BUS1′, BUST and at the isolation circuits 50 and 80.

In embodiments in which BUS2 is a wireless bus, the electronic system 12 includes a wireless communication circuit 52 electrically connected via BUS1 to the isolation circuit 50 and also to the BUS1 communication port of the electronic system 12. The electronic system 14 likewise includes a wireless communication circuit 82 electrically connected via BUS2 to the isolation circuit 80 and also to the BUS2 communication port of the electronic system 14. The BUS2 interface between the two electronic systems 12 and 14, illustrated in FIG. 1 as the dashed line between the two BUS2 ports of the electronic systems 12 and 14, is thus, in this embodiment, a wireless link or channel which may be or include a radio frequency (RF) or other electromagnetic link and/or an internet link. In embodiments in which BUS2 is a radio frequency (RF) link, the wireless communication circuits 52 and 82 may be provided in the form of conventional radio transceivers. In embodiments in which BUS2 is an internet link, the wireless communication circuits 52 and 82 may be conventional circuits configured for internet access. In some embodiments in which BUS2 is a wireless bus, an auxiliary hardwire bus, BUS2AUX, may be interconnected between the isolation circuits 52 and 82 to provide for further redundancy in the BUS2 connection.

In other embodiments, BUS2 is a hardwire interface connected between the BUS2 communication ports of the two electronic circuits 12 and 14. In some such embodiments, the wireless communication circuits 52 and 82 are illustratively omitted such that the BUS2 ports of the electronic systems 12 and 14 connect directly to the isolation circuits 50 and 80. In other embodiments, the electronic circuits 12 and 14 may additionally include the wireless communication circuits 52 and 82 to provide for further redundancy, i.e., in the form of a wireless link, in the BUS2 connection. Any such redundant connection of BUS2 may include any pair or other combination of a hardwire interface, an RF or other electromagnetic interface and an internet link.

In the electronic system 12, the shared bus, SBUS, is coupled via the isolation circuits 34 and 52 to both of BUS1′ and BUS2′, and the control circuit 30 thus has data access to SBUS 38 via either BUS1′ or BUS2′. Likewise, the shared bus, SBUS, 68 in the electronic system 14 is coupled via the isolation circuits 64 and 80 to both of BUS1′ and BUS2′, and the control circuit 60 thus has data access to SBUS 68 via either BUS1′ or BUS2′.

The electronic system 12 may include one or more conventional sensors 40, one or more conventional actuators 42, one or more conventional switches 44, one or more conventional electronically controlled modules or subsystems 46 and/or one or more other auxiliary electrical components 48, each connected to SBUS 38 via a number, J, of signal paths, where J may illustratively be 1 or 2. In the former case, each individual sensor 40, actuator 42, switch 44, module or subsystem 46 and auxiliary electrical component 48 is electrically connected to SBUS via a signal line or path, and in the latter case each is electrically connected to SBUS via two independent and redundant signal lines or paths to ensure connections to the various components are not lost in the event a single signal line or path to any such component is lost. Likewise, the electronic system 14 may include one or more conventional sensors 70, one or more conventional actuators 72, one or more conventional switches 74, one or more conventional electronically controlled modules or subsystems 76 and/or one or more other auxiliary electrical components 78, each connected to SBUS 68 via a number, J, of signal paths, where J may illustratively be 1 or 2 as described above. In any case, for purposes of this disclosure, the control circuit 30, the one or more sensors 40, the one or more actuators 42, the one or more switches 44, the one or more modules or subsystems 46 and the one or more auxiliary electrical components may all collectively be referred to herein as electrical components of the electronic system 12, and the control circuit 60, the one or more sensors 70, the one or more actuators 72, the one or more switches 74, the one or more modules or subsystems 76 and the one or more auxiliary electrical components may all collectively be referred to herein as electrical components of the electronic system 14.

It should now be apparent from the foregoing that dual independent and redundant data bus interfaces and paths, BUS1, BUS1′ and BUS2, BUS2′ are provided to each of the control circuits 30 and 60 in the remote electronic systems 12 and 14. In some embodiments, each such interface BUS1 and BUS2 may further include one or more additional, redundant data interfaces, e.g., in the form of a hardwire connection BUS1AUX and/or BUS2AUX or in the form of a wireless link via wireless communication circuits 36, 66 and 52, 82. Within each of the electronic systems 12 and 14, BUS1′ and BUS2′ are further each coupled to a common or shared bus, SBUS, which is electrically connected to one or more sensors, actuators, switches, electronic modules or subsystems and/or one or more auxiliary actuators. In one embodiment, additional electrical connection redundancy is provided by connecting each such electrical component to SBUS via two independent signal paths or wires, and in less redundantly connected systems each such electrical component is connected to SBUS via only a single signal path or wire.

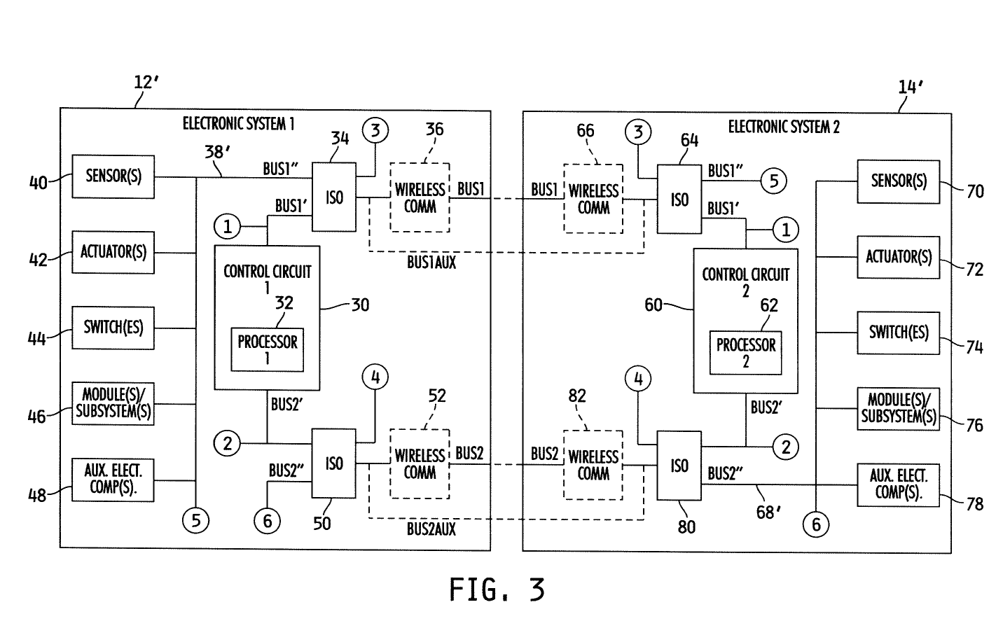

Referring now to FIG. 3, an even less redundantly connected system is illustrated in which SBUS is not shared, i.e., coupled, between BUS1′ and BUST. Rather, SBUS in the electronic system 12′ is renamed BUS1″ and is coupled within the electronic system 12 only to BUS1′ and not to BUS2′. Likewise, SBUS in the electronic system 14′ is renamed BUS2″ and is coupled within the electronic system 14′ only to BUST and not to BUS1′. In the electronic system 12′, BUS1″ is connected to a signal path connection point 5, and a corresponding BUS2′ connection point to the isolation circuit 50 is terminated at point 6. In the electronic system 14′, BUS2′ is connected to a signal path connection point 6, and a corresponding BUS1″ connection point to the isolation circuit 64 is terminated at point 5. In all other respects, the system illustrated in FIG. 3 is identical in structure and operation to that illustrated and described with respect to FIG. 2.

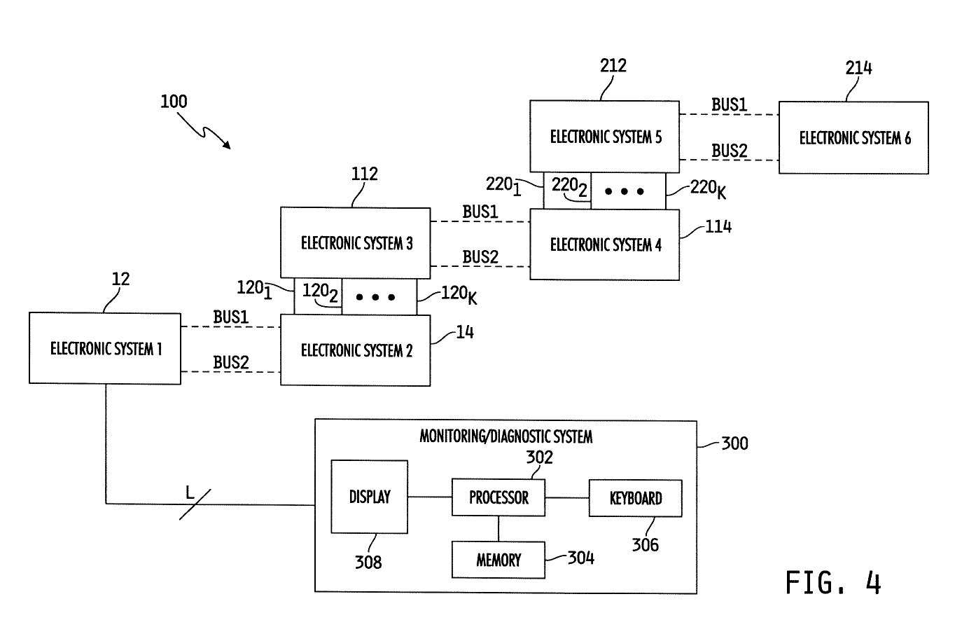

Referring now to FIG. 4, a block diagram is shown of one illustrative embodiment of a system 100 which includes three interconnected pairs of the remotely connected electrical systems illustrated in FIGS. 1-3. This may be done, for example, to piecewise control a multiple structured apparatus. For example, electronic systems 12 and 14, including redundant electrical networks connected therebetween, may be positioned at remote ends of one structure and interconnected via BUS1 and BUS2 as described above. A second set of electronic systems 112 and 114, including redundant electrical networks connected therebetween, may then be positioned at the end of the one structure and the opposite end of another structure extending therefrom. A third set of electronic systems 212 and 214, including redundant electrical networks connected therebetween, may further be positioned at the end of the second structure and the opposite end of yet another structure extending therefrom. Adjacent pairs of electronic systems are connected together at their common internal connection points as illustrated in FIGS. 2 and 3. For example, in embodiments in which the electronic system 14 and 112 are as illustrated in FIG. 2, K=4 and the signal paths 120₁, 120₂ . . . 120_{K} are used to connect points 1-4 (see FIG. 2) of the electronic system 14 to the same points 1-4 of the electronic system 112. In other embodiments in which the electronic system 114 and 212, for example, are as illustrated in FIG. 3, K=6 and the signal paths 220₁, 220₂ . . . 220_{K} are used to connect points 1-6 (see FIG. 3) of the electronic system 114 to the same points 1-6 of the electronic system 212.

A multi-paired system such as illustrated in FIG. 4 is advantageous in apparatuses having multiple extended structures requiring control at each end thereof. For example, the system 100 illustrated in FIG. 4 may be implemented in a fire truck having an articulating boom for transporting persons upwardly and downwardly. In such an application, for example, the electronic system pair 12, 14 may be used to extend between a cab of the vehicle to an electrical access point on the rear of the vehicle, the electronic system pair 112, 114 may be used to extend between the electrical access point and a pedestal at the base of the boom, and the electronic system pair 212, 214 may be used to extend from the pedestal at the base of the boom to a platform at the end of the boom. It will be understood that the system 100 may include any number of interconnected sets of such electrical systems including as few as one and with no upper limit.

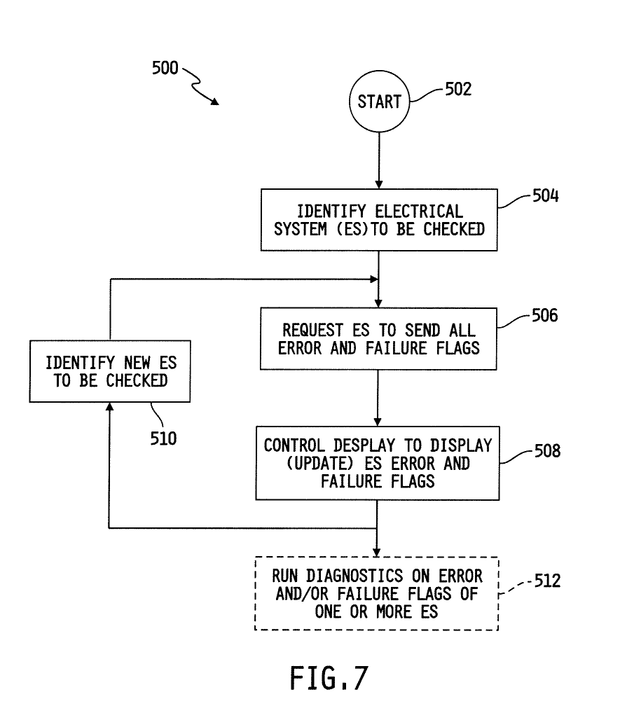

The system 100 may further include a monitoring and/or diagnostic system 300 electrically connected via a number, L, of signal paths to at least one of the electronic systems, e.g., the electrical system 12 as illustrated by example in FIG. 4, for the purpose of monitoring connection errors and failures and/or diagnosing such connection errors and failures of one or more of the electronic systems or system pairs. L may by any integer. In the illustrated embodiment, the monitoring and/or diagnostic system 300 includes a conventional processor 302 electrically connected to a conventional memory unit 304, a conventional keyboard 306 and a conventional display unit 308. The memory illustratively has one or more sets of instructions stored therein that are executable by the processor 302 to carry out monitoring and/or diagnostic operations. One brief example of such instructions and associated process is illustrated and will be described in greater detail hereinafter with respect to FIG. 7.

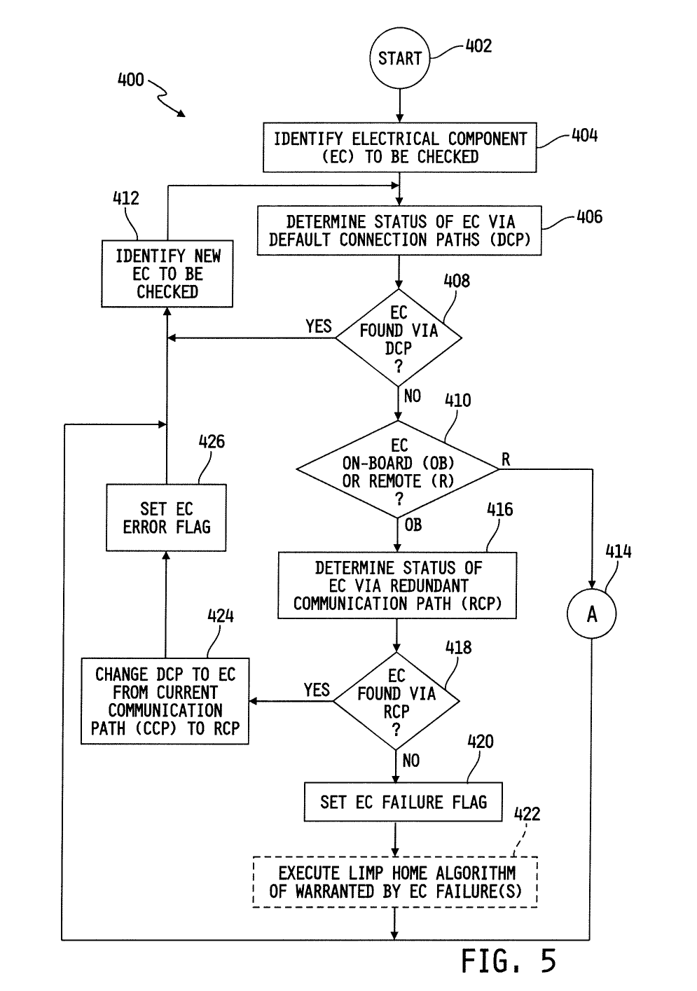

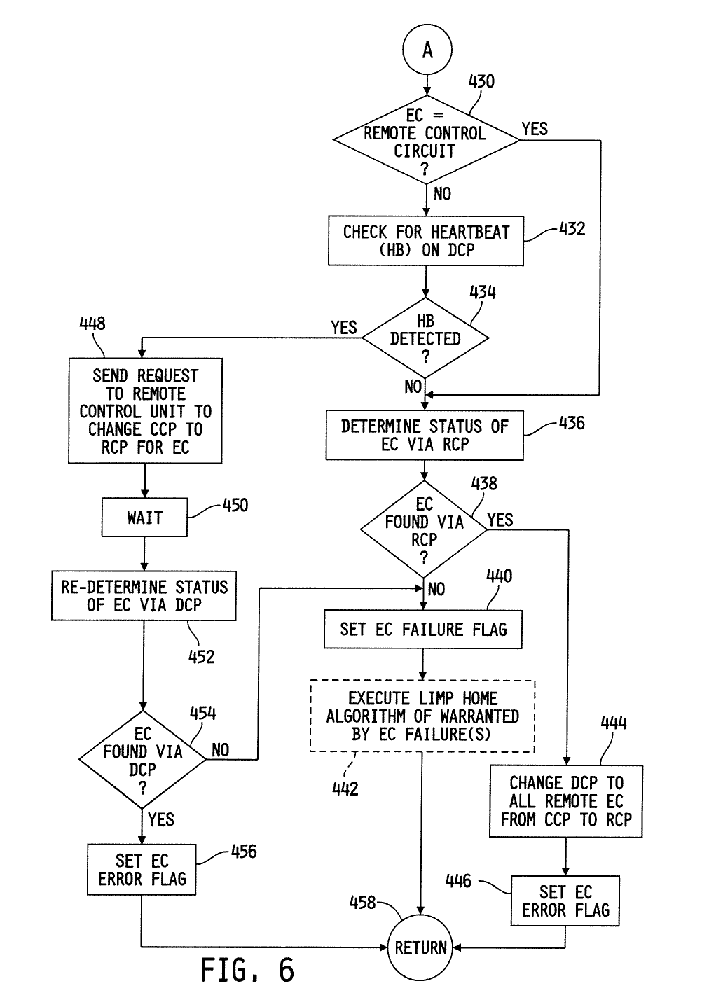

Referring now to FIGS. 5 and 6, a flowchart is shown illustrating one illustrative embodiment of a process 400 for detecting loss of electrical connection in one electrical network and rerouting the connection via the other network in either of the embodiments illustrated in FIGS. 2 and 3. The process 400 is illustratively provided in the form of one or more sets of instructions stored in a memory of the processor of each of the remote electronic systems 12 and 14 and executable by each such processor to determine electrical connection loss and reroute such connections to maintain integrity and operability of the system. More specifically, in the event that one or more electrical connections in one of the network paths is lost due to damage, disconnect or other event or condition, the processors 30 and 60 operate, e.g., under the direction of the process instructions illustrated in FIGS. 5 and 6, to operate to reroute the one or more electrical connections in the other network path to restore and maintain electrical connection between the two systems 12 and 14.

In one illustrative embodiment, the memory of the processor 32 of the control circuit 30 has “default connection path” instructions stored therein that are executable by the processor 30 to electrically access any of the on-board electrical components 40, 42, 44, 46 and 48, and to send messages, e.g., instructions, requests and other information, to the control circuit 60 of the remote electrical system 14. In one illustrative example, such a “default connection path” for the control circuit 30 is via BUS1′ such that the processor 32 of the control circuit 30 accesses, i.e., sends control signals to and/or receives sensory information from, all electrical components 40, 42, 44, 46 and 48 via BUS1′ and accesses, i.e., sends messages to and receives messages from, the control circuit 60 of the remote electrical system 14 via BUS1′ and BUS1. Likewise, the memory of the processor 62 of the control circuit 60 has “default connection path” instructions stored therein that are executable by the processor 60 to electrically access any of the on-board electrical components 70, 72, 74, 76 and 78, and to send messages, e.g., instructions, requests and other information, to the control circuit 30 of the remote electrical system 12. For example, one such “default connection path” for the control circuit 60 is via BUS1′ such that the processor 62 of the control circuit 60 accesses, i.e., sends control signals to and/or receives sensory information from, all electrical components 70, 72, 74, 76 and 78 via BUS1′ and accesses, i.e., sends messages to and receives messages from, the control circuit 30 of the remote electrical system 12 via BUS1′ and BUS1. It will be understood that the “default connection path” for either control circuit 30 and/or 60 may alternatively be BUS2′ and BUS2, or some combination of BUS1, BUS1′, BUS2 and BUS2′. In any case, the “default connection path” instructions executed by the processors 32 and 62 establish and direct access by the respective control circuit 30 and 60 to the various on-board and remote electrical components, and in this regard the term “default connection path” used in relation to either of the control circuits 30 and 60 means the current access path by the processor of that control circuit 30 or 60 to the various on-board electrical components and to the various electrical components of the remote electronic system. The process 400 illustrated in FIGS. 5 and 6 is continually executable by each processor 32 and 62 to monitor access to all on-board and remote electrical components and to redefine the “default connection path” to any one or more such electrical components as necessary in order to maintain electrical connection and/or electrical access thereto.

For purposes of the following description of the process 400, reference will be made and examples will be given in the context of the process 400 being executed by the processor 32 of the control circuit 30, although it will be understood that the process 400 is also continually executed by the processor 62 of the control circuit 60 at the same time it is being executed by the processor 32 of the control circuit 30. Additionally, the “default connection path” for the processor 32 and control circuit 30 will, for purposes of the following description, be assumed to be via BUS1′ and BUS1, although other default connection paths may alternatively be used as described above. As will be described in greater detail hereinafter, the processor 32 is operable according to the process 400 to change the definition of the “default connection path” for one or more on-board and/or remote electrical components as necessary to maintain electrical connection and/or access thereto.

Referring now specifically to FIG. 5, the process 400 begins at step 402, and thereafter at step 404 the processor 32 identifies a first electrical component, EC, to be checked. The first electrical component may be any of the on-board electrical components or any of the remotely connected electrical components including the remote control circuit 60. The identity of the first electrical component may, for example, be stored in memory such that the process 400 begins with checking the same first electrical component each time the process 400 is initiated. In any case, the process 400 advances from step 404 to step 406 where the processor 32 determines the status of the first electrical component via the default connection path, DCP. Using the example criteria set forth above and assuming the first electrical component, EC, is, for example, one of the local sensors 40 on-board the electronic system 12, the processor 32 is operable to execute step 406 by checking the status of the sensor 40 via the connection path established by BUS1′ and SBUS 38. In fact, if the first, or any subsequently identified, electrical component is any of the electrical components 40, 42, 44, 46 or 48, the processor 32 executes step 406 to check the status of that electrical component by checking for electrical connection to that electrical component via the default connection path established by BUS1′ and SBUS 38. If instead the first, or any subsequently identified, electrical component is any of the electrical components of the remote electronic system 14, the processor 32 executes step 406 to check the status of that electrical component by sending a message requesting the status of the electrical component to the control circuit 60 via the default connection path established by BUS1′ and BUS1. This example holds for both embodiments of the electronic systems 12, 14 illustrated in FIGS. 2 and 3. In any case, execution of the process 400 advances from step 406 to step 408 where the processor 32 determines whether the electrical component, EC, checked at step 406 was found via the default connection path, DCP. If so, the process 400 advances to step 412 where a new or next electrical component, EC, to be checked is identified, and execution of the process 400 then loops from step 412 back to step 406. Illustratively, the memory of the processor 32 has stored therein a list of all electrical components to be checked, the order of which may be arbitrary.

If, at step 408, the electrical component, EC, checked at step 406 was not found, the process 400 advances to step 410 where the processor 32 is operable to determine whether the electrical component, EC, is local, i.e., on-board the electronic system 12, or is remote, i.e., on-board the remote electronic system 14. If the processor 32 determines at step 408 that the electrical component, EC, is remote, the process 400 advances to step 414 where the process 400 executes a subroutine A, an example of which is depicted in FIG. 6. If, instead, the processor 32 determines at step 410 that the electrical component, EC, is on-board the electrical system 12, the process 400 advances to step 416 where the processor determines the status of the electrical component via the redundant communication path, RCP. Continuing with the above example in which the electrical component, EC, is one of the sensors 40 and in which the default connection path, DCP, is the combination of BUS1′ and SBUS, one possible reason why EC was not found at step 406 is that BUS1′ may be inoperative, and a redundant communication path to the sensor 40 in the embodiment illustrated in FIG. 2 can be established via the combination of BUS2′ and SBUS 38. In this embodiment, the “redundant communication path” to the sensor 40, or to any of the electrical components 40, 42, 44, 46 and 48, is the electrical connection path established by BUS2′ and SBUS 38. In this example, then, the processor 32 is operable to execute step 416 by checking the status of the local electrical component, EC, via the redundant communication path established by BUS2′ and SBUS 38. Following step 416, the process 400 advances to step 418 where the processor 32 is operable to determine whether the electrical component, EC, was found at step 416 via the redundant communication path, RCP. If not, this means that there is a connection problem with the interface between SBUS 38 and the electrical component, EC, e.g., the one or more signal paths between the electrical component, EC, and SBUS 38 has failed, or that the electrical component, EC, itself is non-functional. In either case, the process 400 advances to step 420 where the processor 32 sets a failure flag in memory that is specific to the electrical component, EC. In some embodiments, the memory of the processor 32 may have stored therein a so-called “limp home” algorithm which, when executed by the processor 32, causes the processor 32 to control a subset of features of the electronic system 12, e.g., a minimal function set of features, that allow the apparatus controlled by the electronic system 12 to be moved to safety and/or operated in a safe manner until suitable repairs can be made. In such embodiments, the process 400 may include step 422 as illustrated by dashed-line representation in FIG. 5, and the processor 32 is operable in such embodiments to execute step 422, after step 416, such that the processor 32 will be directed to execute the limp home algorithm if warranted by the detected failure or failures of one or more electrical components. Those skilled in the art will recognize that, depending upon the application, some electrical component failures and/or combinations of certain electrical component failures may warrant execution of the limp home algorithm while others may not, and that the identification of such failures will therefore depend upon the specific application of the concepts described herein. In any case, the steps required to cause the processor 32 to execute (or not execute) the limp home algorithm would be a mechanical step to a skilled programmer.

If, at step 418, the processor 32 determines that the electrical component, EC, was found at step 416 via the redundant communication path, RCP, this means that there is a connection or operational problem with BUS1′ but that the interface between SBUS 38 and the electrical component, EC, is intact since the processor 32 was able at step 416 to find the electrical component, EC, via the redundant communication path, RCP, established by BUS2′ and SBUS. In this case, the process 400 advances from step 418 to step 424 where the processor 32 changes or modifies the definition of the default connection path, DCP, to the electrical component, EC, from its current communication path, CCP, to the redundant communication path, RCP. Again referring to the above example in which the electrical component, EC, is one of the sensors 40, if the default communication path, DCP, between the control circuit 30 and the sensor 40 is currently the connection path established by the combination of BUS1′ and SBUS, the processor 32 is operable at step 424 to redefine DCP from this current communication path, CCP, to the redundant communication path, RCP, established by the combination of BUS2′ and SBUS. After execution of step 424, the default connection path, DCP, for the electrical component being tested will thus be the combination of BUS2′ and SBUS, and this electrical connection path will used by the control circuit 30 to access this electrical component during normal operation going forward. In this manner, electrical connection and communication between the control circuit 30 and the local electrical component is maintained even though BUS1′ has been lost. Following step 424, the process 400 advances to step 426 where the processor 32 sets an error flag in memory that is specific to the electrical component, EC, and step 426 then advances to step 412 for selection of the next electrical component, EC.

It should be noted that in the embodiment illustrated in FIG. 3, which has reduced electrical connection redundancy as compared with the embodiment illustrated in FIG. 2 as discussed above, the combination of BUS1′ and BUS1″ is the only electrical connection path to the on-board electrical components 40, 42, 44, 46 and 48. The steps 416, 418, 424 and 426 will therefore typically not be included in the process 400 executed by the processor 32 of the electronic system 12′ illustrated in FIG. 3, and instead if the processor 32 determines at step 408 that an electrical component, EC, was not found via the default connection path, DCP, at step 406, the process 400 advances directly to step 420.

Again using the example criteria set forth above and now assuming the electrical component, EC, being checked at step 406 is one of the remote electrical components, i.e., one of the electrical components 70, 72, 74, 76 or 78 or the remote control circuit 60, the processor 32 is operable to execute step 406 by sending a request message to the remote control circuit 60 via the default connection path established by BUS1′ and BUS1. Under normal operating conditions, the remote control circuit 60 will receive this request message, and the remote processor 62 will process the message to determine the identity of the electrical component to be checked. If the electrical component to be checked, EC, is one of the electrical components 70, 72, 74, 76 or 78, the remote processor 62 will check the status of the electrical component by checking the status of the electrical component via the default connection path, DCP, of the remote system, e.g., the connection path established by BUS1′ and SBUS 68. If the electrical component is found, the remote processor 62 will send a “found” message to back to the processor 32 via the default connection path, DCP, e.g., via the communication link established by BUS1′ and BUS1 of both systems 12 and 14. The processor 32 will then process this message to determine that the remote electrical component was found. If the electrical component, EC, to be checked at step 406 is instead the remote control circuit 60, the processor 32 is illustratively operable at step 406 to check the status of the remote control circuit 60 by monitoring the default connection path, e.g., BUS1′ and BUS1, for a so-called “heartbeat.” Illustratively, each of the processors 32 and 62 periodically, e.g., every 50 milliseconds or so, broadcasts a so-called “heartbeat” message or pulse on the default communication path, DCP, which, when detected by the other, remote processor, lets that processor know that the communication link established between the two remote electronic systems 12 and 14 by the default connection path, DCP, e.g., BUS1, has not been lost and that the remote processor is still functional. Thus, if this communication link, e.g., BUS1, is lost, e.g., has become disconnected or has otherwise failed, no such heartbeat will be detected by the processor 32 on the default connection path, DCP.

Referring now to FIG. 6, a flowchart is shown of one illustrative embodiment of the subroutine A of step 414 of the process 400 illustrated in FIG. 5. The process 400 reaches subroutine A of step 414 when the electrical component, EC, being checked at step 406 of the process 400 is a remote electronic component that has not been found, i.e., when the electrical component being checked at step 406 is an electrical component of the remote electronic system 14 or 14′ and cannot be found by the processor 32. In the flowchart illustrated in FIG. 6, the process 400 advances from step 414 to step 430 where the processor 32 is operable to determine whether the electrical component, EC, checked at step 406 of the process 400 is the control circuit 60 of the remote electronic system 14. If so, the process 400 advances to step 436. If not, the process 400 advances to step 432 to check for the heartbeat, HB, on the default connection path, DCP. It should be noted that it is this process of checking for a heartbeat that the processor 32 uses at step 406 when the electrical component to be checked at step 406 is the remote control circuit 60, and step 430 is therefore included in the process 400 to bypass re-checking of the heartbeat when it has already been found at step 406 to be missing.

In any case, step 432 advances to step 434 where the processor 32 determines whether the heartbeat was detected at step 432. If not, this means that the reason why the remote electrical component could not be found at step 406 of the process 400 is because BUS1 of the default connection path, DCP, is inoperative or because the remote control circuit 60 is inoperative. In either case, the “NO” branch of the process 400 advances to step 436 where the processor 32 determines the status of the remote electronic component, EC, via the redundant communication path, RCP. Continuing with the above example in which the default connection path, DCP, between the electronic system 12 or 12′ and the remote electronic system 14 or 14′ is the combination of BUS1′ and BUS1, the “redundant communication path” to the remote electronic system 14 or 14′ is the electrical connection path established by BUS2′ and BUS2. In this example, then, the processor 32 is operable to execute step 436 by checking the status of the local electrical component, EC, via the redundant communication path established by BUS2′ and BUS2. Following step 436, the process 400 advances to step 438 where the processor 32 is operable to determine whether the electrical component, EC, was found at step 436 via the redundant communication path, RCP, e.g., by determining, in the case that the remote electronic component, EC, is one of the electronic components 70, 72, 74, 76 or 78, whether a message from the remote processor 62 was received via RCP indicating that the remote electronic component was found or, in the case that the remote electronic component, EC, is the remote control circuit 60, by determining whether the heartbeat is detectable via RCP. If not, this means that there is a connection problem with BUS1 or that the remote control circuit 60 is inoperable or otherwise cannot transmit the heartbeat. In either case, the process 400 advances to step 440 where the processor 32 sets a failure flag in memory that is specific to the electrical component, EC. In embodiments that include a limp home algorithm as discussed hereinabove, the process 400 may further include step 442 that is executed after step 440 in which the processor 32 executes the limp home algorithm if warranted by the failure of one or more electrical components. Step 442 then advances to step 458 where the subroutine is returned to step 414 of the process 400.

If, at step 438 the processor 32 determines that the electrical component, EC, checked at step 436 was found via the redundant communication path, RCP, this means that only the communication link BUS1 is faulty, and that the remote control circuit 60 and the remainder of the default connection path, DCP, within the remote electronic system 14 or 14′ is intact and operational. In such cases, the process 400 advances to step 444 where the processor 32 changes or modifies the definition of the default connection path, DCP, to all of the electrical components, EC, in the remote electronic system 14 or 14′, including the remote control circuit 60, from their current communication paths, CCP, to the redundant communication path, RCP. Again referring to the example used above in which the default communication path, DCP, between the control circuit 30 and the remote control circuit 60 is currently the connection path established by the combination of BUS1′ (in both electronic systems 12 and 14) and BUS1, the processor 32 is operable at step 444 to redefine DCP from this current communication path, CCP, to the redundant communication path, RCP, established by the combination of BUS2′ (in both electronic systems 12 and 14) and BUS2. After execution of step 444, the default connection path, DCP, for all such remote electrical components, i.e., all electrical components of the remote electrical system 14, will thus be the combination of BUS2′ (in both electronic systems 12 and 14) and BUS2, and this electrical connection path will used by the control circuit 30 to access all such remote electrical components during normal operation going forward. In this manner, electrical connection and communication between the electronic system 12 or 12 and the remote electronic system 14 or 14′ is maintained even though BUS1 has been lost. Following step 444, the process 400 advances to step 446 where the processor 32 sets an error flag in memory that is specific to all remote electrical components, EC, affected by the loss of BUS1, and step 446 then advances to step 458 where the subroutine is returned to step 414 of the process 400.

If, at step 434, the heartbeat was detected by the processor 32, this means that the default communication link between the two electronic systems 12 or 12′ and 14 or 14′, e.g., BUS1, is intact and the remote control circuit 60 is operational, and that the failure to find the remote electrical component, EC, i.e., one of the electrical components 70, 72, 74, 76 or 78, is due to a connection or electrical component problem within the remote electronic system 14 or 14′. In such cases, the processor 32 is operable at step 448 to send a message to the remote control circuit 60 via the default connection path, e.g., via the combination of BUS1′ and BUS1, which contains a request for the remote processor 62 to change, with respect to the specific remote electrical component, its current internal connection path, CCP, from its internal default connection path, DCP, to a redundant connection path, RCP. The remote processor 62 is responsive to this message request to attempt to re-route its internal electrical connection to the electrical component being checked, e.g., by executing steps 416, 418, 424 and 426 of the process illustrated in FIG. 5. The process 400 advances from step 448 to step 450 where the processor 32 waits for a time period to allow the remote processor 62 to re-route the electrical connection to the electrical component being tested. Thereafter at step 452, the processor 32 re-determines the status of the remote electrical component, EC, via the default connection path within the electronic system 12 or 12′, i.e., the processor re-executes at step 452 the process of step 406. Thereafter at step 454, the processor 32 determines whether the remote electrical component was found via the default connection path, DCP, internal to the electronic system 12 or 12′, i.e., the processor 32 determines at steps 452 and 454 whether the remote processor 62 was able to successfully re-route an electrical connection to the electrical component being checked. If so, the process 400 advances to step 456 where the processor 32 sets an error flag in memory for the electrical component being checked, and the process advances from step 456 to the return step 458. If, at step 454, the processor 32 instead determines that the remote processor 62 was not able to successfully re-route an electrical connection to the electrical component being checked, the process 400 advances to step 440 where the processor 32 sets a failure flag in memory for the electrical component being checked.

Referring now to FIG. 7, a flowchart is shown of one illustrative process 500 for monitoring and/or diagnosing error and failure conditions in the system 100 illustrated in FIG. 4. As described hereinabove, the system 100 may include a single pair or one or more sets of interconnected pairs of electronic systems of the type illustrated and described with respect to FIG. 2 and/or 3, and the monitoring/diagnostic system 300 is operable to monitor and/or diagnose error and/or failure conditions associated with one or more such interconnected pairs of electronic systems. In embodiments of the system 100 that include only a single interconnected pair of electronic systems, e.g., electronic systems 12 and 14, the monitoring/diagnostic system 300 may be connected to the control circuit 30 of the electronic system 12 or to the control circuit 60 of the electronic system 14, and the processor 302 is operable to retrieve the electrical component error and/or failure information from both electronic systems 12 and 14 via either such control circuit. In so doing, the processor 302 is operable to send the subject control circuit instructions to send electrical component error and failure information relating to the system in which the control circuit resides, and to also send the subject control circuit instructions to request such error and failure information from the remote electronic system and provide such information to the processor 302. In embodiments of the system 100 that include multiple interconnected pairs of electronic systems, the monitoring/diagnostic system 300 may be connected to the control circuit of any electronic system in any interconnected pair, and the processor 302 may be operable in such embodiments to instruct the control circuit to which it is connected to extract electrical component error and/or failure information from all electronic systems in the system 100 and to provide such information to the processor 302.

The process 500 illustrated in FIG. 7 may be stored in the memory 304 in the form of one or more sets of instructions that are executable by the processor 302 to monitor, display and/or diagnose electrical component error and/or failure information of one or more of the electrical systems in the system 100. The process 500 begins at step 502, and thereafter at step 504 the processor 302 is operable to identify one of the electrical systems, ES, to be checked for electrical component error and/or failure information, e.g., any one of the electrical systems 12, 14, 112, 114, 212 or 214 illustrated in FIG. 4. In one embodiment, an operator may input ES at step 504, and in alternate embodiments the processor 302 may be programmed to automatically select ES. In any case, the process 500 advances from step 504 to step 506 where the processor 302 sends a request to the selected electrical system to send to the processor 302 all electrical component error and/or failure information, e.g., all electrical component error and/or failure flags. Thereafter at step 508, the processor 302 is operable to control the display 308 to display the error and/or failure flags of the selected electronic system, or to update the display with any new error and/or failure flags of the selected electronic system in embodiments in which the error and/or failure flags for the selected electronic system is continually displayed. Thereafter at step 510, the processor 302 identifies a new or next electronic system to be checked, and step 510 then loops back to step 506. The process 500 may further include a step 512, as illustrated by dashed-line representation, which follows step 508 and in which the processor 302 runs one or more diagnostic routines that process electrical component error and/or failure information of one or more of the electrical systems. In such embodiments, the memory 304 has stored therein one or more diagnostic algorithms which the processor 302 may execute to diagnose or evaluate the electrical component error and/or failure flag information collected from the one or more electrical systems. Such algorithms may be conventional and may include, for example, statistical and/or predictive techniques for further evaluating error and/or failure sources.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, as illustrated in FIGS. 2 and 3, an embodiment is shown in which each of the buses BUS1 and BUS2 may include a hardwire communication link, e.g., BUS1AUX and BUS2AUX respectively, and at least one wireless communication link, e.g., via a wireless communication circuit. In such embodiments, the processors 32 and 62 may be configured to normally conduct communications over either communication channel, e.g., over BUS1 or BUS12, via the hardwire communication link, and to conduct communications via the corresponding wireless link only upon loss of the hardwire link. This feature provides a further level of redundancy that allows either, or each, of the communication paths BUS1 and/or BUS2 to include multiple communication links that may be substituted for another upon detection of a failure or loss of the other. As one specific example, the processor 32 may be configured to normally conduct communication over BUS1 via a hardwire link comprising BUS1, e.g., via BUS1AUX, but may be configured to re-route such communications over BUS1 via a wireless link comprising BUS1, e.g., via wireless communication circuit 36, upon detection of a loss or failure of the hardware link.

What is claimed is:

1. A redundant electrical connection network comprising:
a first electronic system having a first processor and at least one electrical component electrically coupled to the first processor,
a second electric system separate and remote from the first electronic system, the second electronic system having a second processor and at least one electrical component electrically coupled to the second processor,
a first communication link coupled between the first and second processors,
a second communication link coupled between the first and second processors, the second communication link separate and isolated from the first communication link, the first and second processors configured to normally conduct data communications solely via one of the first and second communication links, and at least one of the first and second processors configured to monitor the one of the first and second communication links and re-route the data communications solely to the other of the first and second communication links upon detection of loss of the one of the first and second communication links.

2. The redundant electrical connection network of claim 1 wherein the first processor includes a memory having stored therein instructions that are executable by the first processor to monitor the one of the first and second communication links and to re-route the data communications solely to the other of the first and second communication links upon detection of the loss of the one of the first and second communication links.

3. The redundant electrical connection network of claim 2 wherein the instructions stored in the memory of the first processor include instructions executable by the first processor to monitor the one of the first and second communication links by monitoring the one of the first and second communication links for a periodic occurrence of a heartbeat signal, and to detect the loss of the one of the first and second communication links if the first processor fails to detect the heartbeat signal for at least a predetermined time period.

4. The redundant electrical connection network of claim 1 wherein the first electronic system comprises a first isolation circuit positioned in-line with the first communication link and the first processor and a second isolation circuit positioned in-line with the second communication link and the first processor, the first isolation circuit coupling data communication between the first communication link and the first processor while electrically isolating the first communication link from the first processor, the second isolation circuit coupling data communication between the second communication link and the first processor while electrically isolating the second communication link from the first processor.

5. The redundant electrical connection network of claim 1 wherein the first electronic system comprises a shared data bus coupled to the first and second communication links, the at least one electrical component of the first electronic system electrically coupled to the first processor via the shared data bus.

6. The redundant electrical connection network of claim 5 wherein the first processor is configured to normally electrically access the at least one electrical component of the first electronic system via one of the first and second communication links, and to re-route electrical access to the at least one electrical component of the first electronic system to the other of the first and second communication links upon detection of a loss of the one of the first and second communication links.

7. The redundant electrical connection network of claim 5 wherein the first processor includes a memory having stored therein instructions that are executable by the first processor to monitor the one of the first and second communication links and to re-route the electrical access to the at least one electrical component of the first electronic system to the other of the first and second communication links upon detection of the loss of the one of the first and second communication links.

8. The redundant electrical connection network of claim 7 wherein the instructions stored in the memory of the first processor include instructions executable by the first processor to monitor the one of the first and second communication links by attempting to electrically access the at least one electrical component via the one of the first and second communication links, and to detect the loss of the one of the first and second communication links if the first processor fails to electrically access the at least one electrical component via the one of the first and second communication links.

9. The redundant electrical connection network of claim 1 wherein the first communication link comprises a hardwire communication link, and wherein the second communication link is a wireless communication link.

10. The redundant electrical connection network of claim 1 wherein the first electronic system comprises a first wireless communication circuit coupled between the first processor and the second communication link, and the second electronic system comprises a second wireless communication circuit coupled between the second processor and the second communication link.

11. The redundant electrical connection network of claim 10 wherein the first and second wireless communication circuits each comprise a radio frequency transceiver, and wherein the second communication link is a radio frequency communication link.

12. The redundant electrical connection network of claim 10 wherein the first and second wireless communication circuits each comprise internet accessible circuitry, and wherein the second communication link is an internet link.

13. The redundant electrical connection network of claim 1 wherein at least one of the first and second communication links comprises a hardwire communication link and a wireless communication link, and wherein the first processor is configured to conduct data communications on the one of the first and second communication links via the wireless communication link only upon loss of the hardwire communication link.
